(19) United States
(12) Patent Application Publication
(10) Pub. No.: US 2011/0319703 A1
(43) Pub. Date: Dec. 29, 2011

(54) Implantable Microphone System and Calibration Process

(75) Inventors: Pieter Wiskerke, Macquarie University (AU); Miroslav Havranek, Macquarie University (AU)

(73) Assignee: COCHLEAR LIMITED, Macquarie University (AU)

(21) Appl. No.: 13/124,244

(22) PCT Filed: Oct. 14, 2009
(86) PCT No.: PCT/AU09/01372

§ 371 Date: Sep. 13, 2011

(30) Foreign Application Priority Data
Oct. 14, 2008 (AU) 2008905307

(51) Int. Cl. H04R 25/00

(52) U.S. Cl. 600/25

(57) ABSTRACT

A method of calibrating an implantable microphone for a hearing prosthesis is disclosed. For an implantable microphone which includes a vibration sensor to provide body noise cancellation, a calibration method is disclosed, in which known acoustic and vibration signals are provided by an external device. This may be as part of the external charging system for an implantable device.

### FIELD OF THE INVENTION

The present invention relates to implantable microphone systems, particularly for use with hearing prostheses.

### BACKGROUND TO THE INVENTION

Hearing prostheses of various types are widely used to improve the lives of users. Such devices include, for example, external hearing aids, implanted hearing aids, cochlear implants, middle ear implants and electro-acoustic devices. A current trend is to develop totally implantable forms of these devices. Totally implantable devices have the advantage of allowing the user to have a superior aesthetic result, as the user is visually indistinguishable in day to day activities.

They have a further advantage in generally being inherently waterproof, allowing the user to shower, swim, and so forth without needing to take any special measures. A fully implantable system will allow the user to have hearing while sleeping and so be able to hear, for example, the user's children.

Totally implantable devices, relative to partially implantable devices, have two particular requirements. Such devices require at least a degree of electrical storage or other independent power supply to be provided internally. Totally implanted devices having an implanted battery arrangement require periodic recharging, typically using a transcutaneous RF inductive power arrangement.

Another requirement is to provide a suitable implantable microphone. Conventional hearing prostheses, for example partially implanted cochlear implant systems, use externally disposed microphones. Replacing the external microphone assembly with an implantable microphone assembly presents various practical difficulties. The microphone assembly needs to be biocompatible and hermetically sealed. The presence of a layer of skin or soft tissue overlying the microphone acts to attenuate the air-carried sound signals, through reflection, scattering and absorption. A further loss of signal occurs through impedance matching effects associated with the sound signal passing from air into the body. The implanted microphone is also subject to substantial noise from internal body noises.

An implantable microphone can, for example, be constructed by coupling a transducer (electret, piezo or other pressure sensitive transducer) to the solid floor of a cavity covered by a titanium diaphragm. The diaphragm diameter and thickness and cavity volume can be optimised to maximise the signal level after implantation. However, such a subcutaneous microphone is highly sensitive to bone conducted body noise. This is due to the acceleration of the implant package against the skin. Any mass loading on the titanium diaphragm increases the sensitivity to vibration.

Various microphone structures which reduce the body noise detected by the transducer have been proposed. WO 2005/048646 by Otologics LLC discloses the use of a compliant member arranged so as to mechanically isolate the microphone housing, in order to decrease its sensitivity to transmitted vibration.

Some prior disclosures refer to the use of a motion or other sensor to assist in reducing the impact of body noise and/or motion induced noise on the performance of the microphone. U.S. Pat. No. 7,214,179 to Miller et al discloses the use of an acceleration signal to cancel or modify the effects of such signals on the transducer. Other disclosures include US Patent Application No. 20080132750 by Miller; US Patent Application No 20060155346 by Miller; U.S. Pat. No. 7,556,597 to Miller; and U.S. Pat. No. 6,807,445 to Baumann et al.

It is an object of the present invention to provide an alternative system for calibrating such noise mitigation systems.

### SUMMARY OF THE INVENTION

According to a first aspect of the present invention there is provided a method of calibrating an implantable microphone system, said system including:

a microphone assembly arranged to receive incident signals and produce a corresponding microphone output signal; wherein said incident signals include sound signals and body vibration signals;

a vibration sensor arranged to detect said body vibration signals and produce a corresponding vibration output signal; and

a processor arranged to receive the microphone output signal and the vibration output signal, and process them to produce an adjusted output signal, with the level of vibration output signal at least substantially reduced, said method including the steps of:

providing a known sound signal for reception by said microphone assembly;

providing a known vibration signal for reception by said microphone assembly and said vibration sensor;

comparing the resultant processed signal with the known sound signal; and

on the basis of said comparison, selectively adjusting settings within said processor to optimise system performance.

According to a further aspect of the present invention there is provided an implantable microphone system, said system including:

a phased array of two or more microphone assemblies, each microphone assembly arranged to receive incident signals and produce a corresponding electrical output signal; wherein said incident signals include sound signals and body vibration signals; wherein the sound signals received by each microphone are phase shifted with respect to the sound signals received by the other microphones in said array;

a processor arranged to receive the outputs from each microphone assembly; wherein said processor processes said signals to produce a processed signal wherein the level of body vibration signals is substantially reduced.

According to another aspect, the present invention provides an external device for use with an implanted auditory prosthesis, said prosthesis including an implanted microphone and an implanted part of a transcutaneous power transfer system, said external device including an external part of a transcutaneous power transfer system, and at least one acoustic stimulator, so that said external device can provide calibration signals using said acoustic stimulator for said implanted device.

### BRIEF DESCRIPTION OF THE DRAWINGS

Illustrative implementations of the present invention will now be described with reference to the accompanying figures, in which:

FIG. 1 is a schematic view of a prior art implantable microphone;

FIG. 2 is a flow chart illustrating the functionality of a preferred embodiment of carrying out noise compensation;

FIG. 3 is a schematic view of a microphone assembly according to a preferred embodiment;

FIG. 4 is a flow chart illustrating the functionality of an alternative embodiment for carrying out noise compensation;

FIG. 5 is a schematic view of a preferred arrangement for providing system calibration; and

FIG. 6 is a cross-sectional view of the arrangement of FIG. 5.

### DESCRIPTION OF PREFERRED EMBODIMENTS

The present invention will be described with reference to particular illustrative examples. However, it will be appreciated that the present invention is applicable to any implantable microphone system. It may be applied with any suitable hearing prosthesis system, for example a hybrid electrical/acoustic system, a cochlear implant system, an implantable hearing aid system, a middle ear stimulator or any other suitable hearing prosthesis. It may be applied to a system with totally implanted components, or to a system which additionally includes one or more external components. It will be appreciated that the present implementation is described for illustrative purposes, and its features are not intended to be limitative of the scope of the present invention. Many variations and additions are possible within the scope of the present invention. In particular, other measures to reduce body noise may be combined with the present invention.

The present invention is applicable to an implanted microphone using any form of securing. It is preferred that the microphone is placed between bone and skin. However, the present invention could be employed using a recess made in the bone, anchored to the bone, secured by stitching, or any other suitable arrangement.

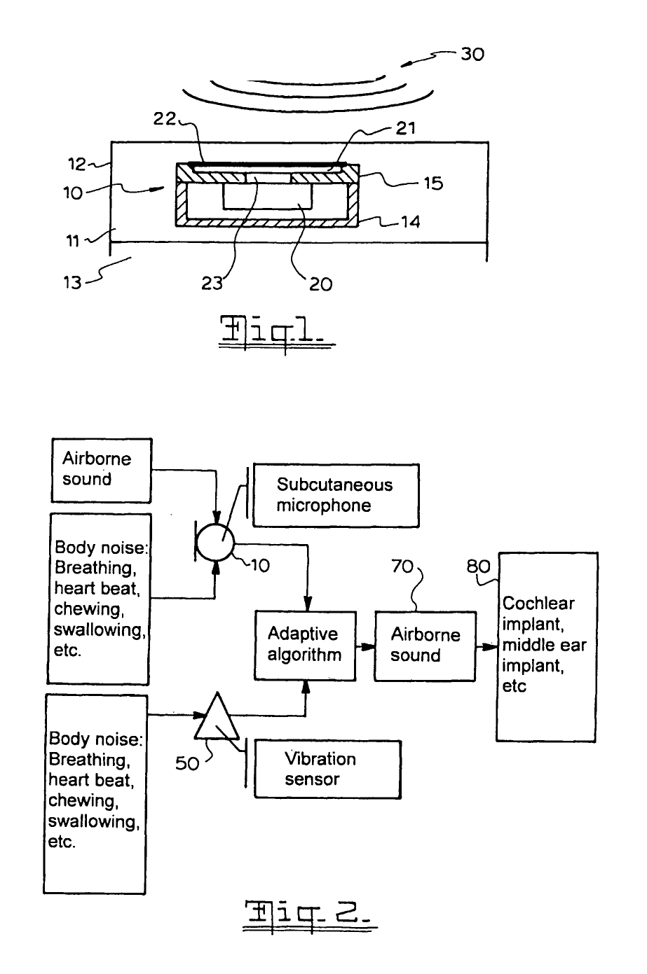

Before proceeding to describe the present invention, it is useful to consider the principles of a subcutaneous implantable microphone. Referring to FIG. 1, a microphone assembly 10 is positioned in tissue 11, adjacent to bone 13 and beneath skin 12. Microphone assembly 10 includes a casing 14 and a supporting element 15 for microphone element 20, which may be of electret, piezo, or any other suitable type. Possible alternative transducers include optical, induction (such as magnetostriction, ribbon, moving coil), condenser, liquid and any other sensor elements capable of sensing either a pressure variation or a deflection of the diaphragm. The present invention is capable of being implemented with any type of transducer.

Microphone transducer is coupled to the rigid floor so as to define a small air or gas filled cavity, which forms an acoustic volume 21. Acoustic volume is enclosed by diaphragm 22, which is suitably formed from titanium, titanium alloy, or any other suitable material. Diaphragm 22 vibrates due to airborne sound 30 impinging on skin 12, and this vibration causes the pressure inside acoustic volume 21 to change. This pressure difference is sensed by the microphone element, connected to the acoustic volume by coupling hole 23, which transduces the acoustic signal into an electrical signal.

Body induced vibrations are transmitted via bone, for example skull bone. These vibrations accelerate the microphone assembly 20, and this acceleration causes diaphragm 22 to vibrate. This is turn creates pressure differences inside acoustic volume 21, which are sensed by the microphone transducer. The mass loading of skin tissue on top of diaphragm 22 acts to increase the sensitivity of microphone assembly 20 to vibration. Further, the mass loading by skin has the effect of shifting the resonance frequency of the diaphragm 22 towards lower frequencies. Typically the resonance frequency is shifted down so it comes within the audio frequency range. The mass loading of skin, due to skin thickness and other skin properties, can vary over time. Such varying properties include humidity, flexibility and amount of fat, etc. These variations have the resultant consequence that the mass loading effect is varying over time.

FIG. 2 illustrates a functional flow chart of an illustrative system which provides noise reduction. As discussed, microphone assembly 10 detects desired sound signals as well as undesired body noise or vibrations. As a first stage in compensating for the body noise, a vibration sensor 50 is provided which picks up the body noise, but not the airborne signal, or at least only in a limited way. The electrical output from microphone assembly 10 is processed with the electrical output from vibration sensor 50, preferably using an adaptive algorithm.

The adaptive algorithm essentially subtracts the vibration sensor output, i.e. the detected noise, from the microphone output, thereby in principle cancelling or at least removing a substantial part of the vibration signals. One example of such an algorithm is described in U.S. Pat. No. 6,807,445, assigned to Cochlear Limited. Other examples of adaptive algorithms are described in U.S. Pat. No. 7,214,179 and US Patent application No. 20060155346.

The resultant signal 70 is preferably substantially only the desired sound signals, however, benefit is obtained even from a less complete reduction in body noise and movement related signals. This resultant signal can then be used, for example, to provide stimulation signals to an electrode array of a cochlear stimulation system 80, or as a basic input signal for any other type of hearing prosthesis.

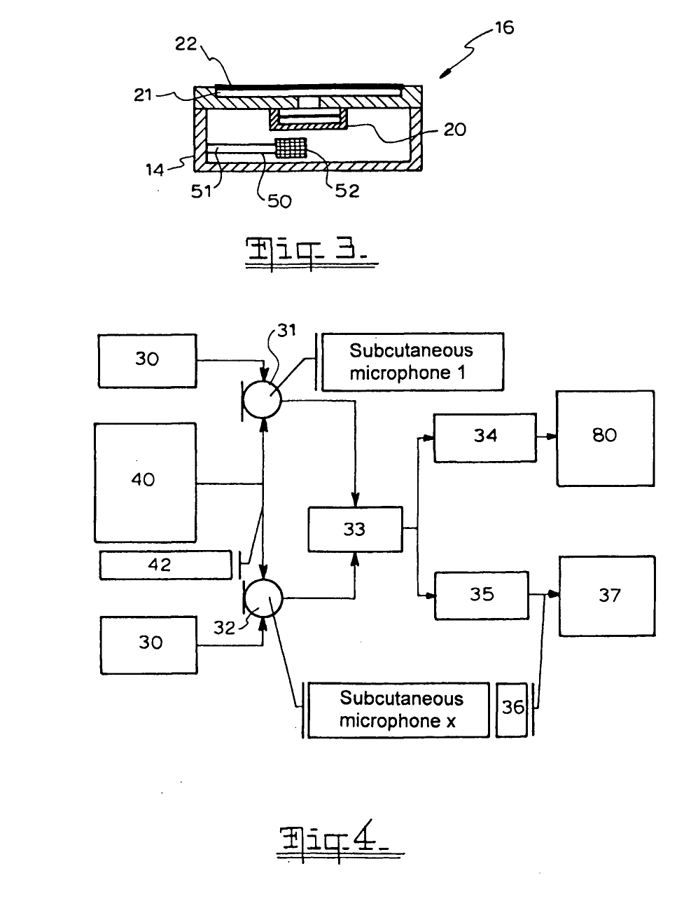

FIG. 3 illustrates an example of a microphone assembly 16 suitable for implementing the above system. Assembly 16 includes, similar to FIG. 1, diaphragm 22, acoustic cavity 21, housing 14, and microphone element 20. It additionally includes a vibration sensor 50. Ideally, as illustrated, vibration sensor 50 is enclosed in the same housing 14 as the microphone element 20. However, it is conceived that in less preferred variations vibration sensor 50 is provided in a separate implanted casing.

Vibration sensor 50 is shown in the form of a piezo bender 51 with a reference mass 52 at its tip. The mass and piezo bender specifications should be chosen such that its vibration sensitivity is in the same range as the selected microphone with a typical skin mass on top of the diaphragm of the microphone assembly.

An example of such a vibration sensor was constructed using a bimorph piezoelectric element of 4×8×0.65 mm thickness. This was fixated in the middle with a screw through a hole in the piezoelectric material. On both ends of the piezoelectric element a copper mass of about 2 grams was placed. This sensor was placed inside on the bottom of a titanium cylindrical casing. The microphone as described above can be placed in the same casing, preferably directly above the vibration sensor with the axis of the diaphragm collinear with the axis of the screw that fixates the piezoelectric element. This acted as an effective vibration sensor.

Given that the vibration sensor is intended to detect only body noise, its position should be chosen so that it is isolated from sound signals as far as practical. Similarly, for optimum performance, the direction of the vibration sensor should be aligned to sense vibrations in the same plane as the diaphragm of the microphone assembly.

It will be appreciated that the piezo bender arrangement is but one suitable form of vibration sensor. Alternative sensors could include accelerometers, velocity sensors and force sensors. Similarly, while FIG. 3 illustrates the use of only one vibration sensor, a plurality of sensors could be employed.

An alternative embodiment is shown in FIG. 4. In this embodiment a phased array of two or more microphones 31, 32 (illustratively 2) are employed. Each microphone 31, 32 will pick up the desired sound signals 30 as well as undesired body noise or vibrations 40. Due to the physical distance 42 between microphones 31, 32, the sound signals received by each microphone will be shifted in phase with respect to the sound signals received by the other microphone(s) in the array. On the other hand, the vibration signals received by each microphone will be substantially in phase.

When the microphones are placed in one hermetic package, this can be understood since the bone conducted vibrations will accelerate the package and thus the two microphones to the skin. This will result in deflection of the diaphragms of both microphones instantly. When the microphones are in separate packages the vibration signal would still be substantially in phase compared to the acoustic signal, since the speed of sound in bone is five times higher then in air. The electrical output from each microphone is processed 33 with respect to each other, preferably using an adaptive algorithm.

A suitable algorithm is identical to the beamformer algorithm used in hearing aids and also in the Freedom sound processor (available commercially from the applicant) to enhance directionality. This algorithm is also described in the following references assigned to the applicant: US Patent Application No 20070055505A1; European patent application No. 1652404A1; PCT publication No WO05006808A1. The use of this beamformer algorithm with two microphones is described in a paper titled “An adaptive noise canceller for hearing aids using two nearby microphones” by Vanden Berghe, J. and Wouters, J.; published in ‘Journal of the Acoustical Society of America’, 103, pp. 3621-3626, 1998. The use of this algorithm for this particular application is explained in co-pending Australian provisional patent application no. 2008900633 by Adam Hersbach.

The adaptive algorithm essentially detects the common in-phase vibration signal, i.e. the detected noise, from the microphone outputs, which allows it to cancel the vibration signals from a selected microphone output signal, or at least substantially reduced the level or proportion of signal which is body noise or vibration. The resultant signal 34 is preferably substantially the desired sound signals, although again, benefit is obtained from a less complete reduction. This resultant signal 34 can then be used, for example, to provide stimulation signals to an electrode array of a cochlear stimulation system 80.

While the purpose of the present invention is to cancel noise from microphone signals, it will be appreciated that, in fact, the embodiments are equally capable of extracting signals representative of just the noise signals. Given that these signals are representative of physical characteristics of the implantee, e.g. breathing, heart beat, etc., there may be use in retaining such signals for other purposes, for example a medical diagnostic purpose, rather than simply discarding them. This is shown in FIG. 4. Such health information 35, extracted from the body noise component, may be sent via a wireless link 36 to a separate device, for example a smartphone or PDA 37. It may be that further processing occurs in this device to extract the health significant data. This could be done in the prosthesis itself, or in the external part of the prosthesis, if required.

As previously discussed, vibration sensitivity of an implantable microphone is very dependent upon skin properties (e.g. thickness, specific mass, amount of fat, etc.) of the implantee. These properties can change over time. For example, the amount of fat could increase or decrease over a long period of time. Humidity can affect the skin properties on a seasonal basis. To take these varying factors into account, it is preferred to provide a convenient calibration process for the system. Ideally, such calibration should be done at fairly regular intervals in such a manner that does not inconvenience the implantee.

Fully implanted systems will typically include an implanted battery essential for system power supply. Implanted batteries have been proposed which are rechargeable at regular intervals, ie. every one or two days. This regular interval could prove suitable for the proposed purposes of calibration.

Based upon the above, a preferred embodiment for carrying out system calibration is combined with the apparatus for recharging.

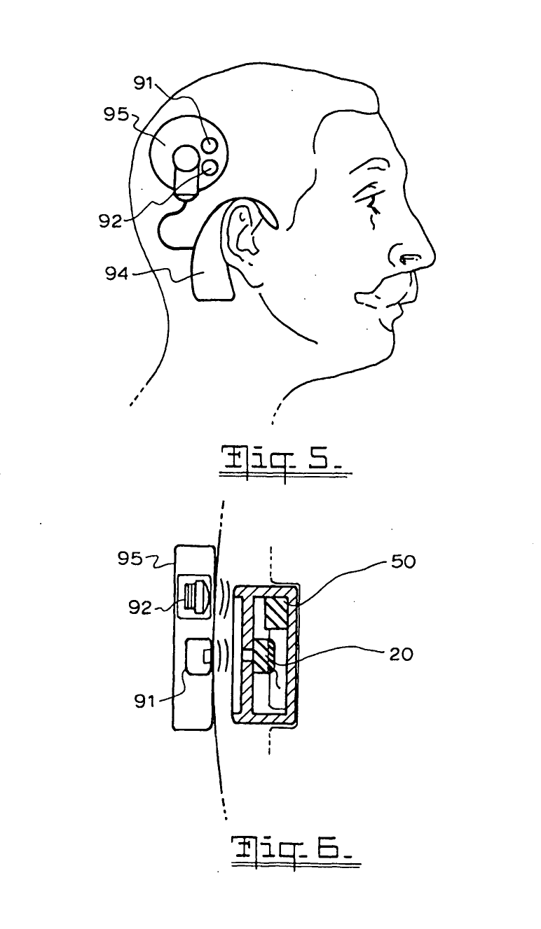

Referring to FIGS. 5 and 6, a recharging system is shown. The system includes a Behind-the ear (BTE) device 94 that transmits power via a coil 95 (RF link) to the implanted device, which has a receiver coil. (not shown). The BTE is in its turn powered by (rechargeable) batteries. The batteries may be in the BTE itself or in a separate device connected via a cable to the BTE. The BTE maybe powered via a transformer directly by the mains. Instead of a BTE a headband containing a transmitter coil or any other recharging device could be used. It will be appreciated that such external powering arrangements, whether associated with a cochlear implant or other implantable device, are widely implemented and well understood by those skilled in the field. The present implementation uses a conventional approach to the power transfer aspects, and adds additional components to facilitate calibration.

For the purposes of calibration, the coil assembly 95 is adapted to include a small speaker 91, which can produce sounds of known amplitude and frequencies. Speaker 91 could be suitably similar to the types used in hearing aid devices. These known sounds are picked up by the implanted microphone assembly 16. Additionally, a small vibrator device 92 is built into the coil assembly 95. This vibrator device 92 can be controlled to produce known vibration signals. The vibrator can take any suitable forms, such as a piezo device, electro-mechanical device or electro-magnetic device.

As will be appreciated, the implanted microphone 20 will pick up the known sound signals and known vibration signals. Similarly, the vibration sensor 50 will pick up the known vibration signals.

These known signals act as reference signals allowing the system to determine whether it is performing optimally or whether setting adjustments need to be made to optimise performance. Ideally, such adjustments are made by adjusting parameters of the adaptive algorithm.

This embodiment of combining the calibration with the battery recharging is attractive because it fixes a position for the speaker and vibrator with respect to the implanted microphone and vibration sensor. Ideally, as shown in FIG. 6, the speaker 92 and vibrator 91 are positioned so as to be aligned respectively to the implanted microphone 20 and vibration sensor 50. This ideal alignment would allow lower levels of sound and vibration to be employed in the calibration process. However, it is conceived that this ideal alignment is not necessarily required. It is more important that the position of the speaker and vibrator be fixed in relation to the implanted microphone and vibration sensor during the calibration process. Calibration is analoguous to the process described in e.g. US patent application No. 2006/0155346 ‘Active vibration attenuation for implantable microphone’ by Miller, but instead of using the actuator external stimulation is used.

It will be appreciated that the described embodiment employing combined calibration with battery recharging is seen as an ideal and convenient arrangement for calibration. However, the calibration could be conducted in a less convenient and separate process to recharging. In such a case, the calibration components could be provided in a device employed specifically for calibrating the system.

The disclosures of all the references noted above detail aspects of implantable microphone systems and their implementation, and the contents of all such disclosures are hereby incorporated by reference.

While the present invention has been described with respect to specific embodiments, it will be appreciated that various modifications and changes could be made without departing from the scope of the invention.

1-16. (canceled)

17. A system, comprising:
an implantable auditory prosthesis having:
a subcutaneous microphone that produces a microphone output signal based on a received incident signal, wherein the incident signal includes a sound signal and a body vibration signal;
a subcutaneous vibration sensor that produces a vibration output signal based on the body vibration signal; and
a processor that processes the microphone output signal and the vibration output signal to produce an adjusted output signal having a body vibration signal component that is at least substantially reduced, wherein the adjusted output signal is for providing auditory stimulation; and
a calibration apparatus having:
a speaker for transcutaneously providing a known sound signal to the implantable auditory prosthesis during a calibration time period; and
a vibrator for transcutaneously providing a known vibration signal to the implantable auditory prosthesis during the calibration time period,
wherein the processor processes the microphone output signal and the vibration output signal produced during the calibration time period to produce a resultant adjusted output signal, and wherein settings within the processor are adjusted based on a comparison of the resultant adjusted output signal with the known sound signal.

18. The system of claim 17, wherein the subcutaneous microphone and the subcutaneous vibration sensor are colocated.

19. The system of claim 17, wherein the calibration apparatus is wearable.

20. The system of claim 17, wherein the calibration apparatus includes one of a behind-the-ear device and a headband for placing the speaker and the vibrator in close transcutaneous proximity to the subcutaneous microphone and the subcutaneous vibration sensor, respectively.

21. The system of claim 17, wherein the processor uses an adaptive algorithm for processing, and wherein the settings within the processor are adjusted by adjusting parameters of the adaptive algorithm.

22. The system of claim 17,
wherein the implantable auditory prosthesis further comprises a subcutaneous rechargeable power supply having a recharging receiver, and
wherein the calibration apparatus further comprises a recharging transmitter for transcutaneously transmitting power to the subcutaneous rechargeable power supply via the recharging receiver to charge the subcutaneous rechargeable power supply during a charging time period.

23. The system of claim 22, wherein the subcutaneous microphone and subcutaneous vibration sensor are colocated in close proximity to the recharging receiver.

24. The system of claim 22, wherein the recharging transmitter and the recharging receiver comprise coils for inductive charging.

25. The system of claim 22, wherein the speaker and the vibrator are placed in close transcutaneous proximity to the subcutaneous microphone and the subcutaneous vibration sensor, respectively, when the coils are aligned for inductive charging.

26. The system of claim 22, wherein the charging time period overlaps with the calibration time period.

27. An apparatus for calibrating an implantable auditory prosthesis, comprising:
a speaker for transcutaneously providing a known sound signal to the implantable auditory prosthesis during a calibration time period, wherein the implantable auditory apparatus includes a microphone for receiving the known sound signal for use in calibrating the implantable auditory prosthesis; and
a vibrator for transcutaneously providing a known vibration signal to the implantable auditory prosthesis during the calibration time period, wherein the implantable auditory apparatus includes a vibration sensor for receiving the known vibration signal for use in calibrating the implantable auditory prosthesis.

28. The apparatus of claim 27, wherein the speaker is colocated with the vibrator.

29. The apparatus of claim 27, further comprising a recharging transmitter for inductively transmitting power to a subcutaneous rechargeable power supply to charge the subcutaneous rechargeable power supply during a charging time period.

30. The apparatus of claim 29, further comprising a first coil, wherein alignment means further aligns the first coil with a second coil associated with the implantable auditory prosthesis for inductive charging.

31. The apparatus of claim 30, wherein the alignment means is for placing the apparatus behind a user's ear.

32. The apparatus of claim 30, wherein the alignment means comprises a headband.

33. A method for calibrating an implantable auditory prosthesis, comprising:
transcutaneously providing to a subcutaneous microphone a known sound signal from an external speaker, wherein the subcutaneous microphone produces a microphone output signal upon receiving the known sound signal;
transcutaneously providing to a subcutaneous vibration sensor a known vibration signal from a vibrator, wherein the subcutaneous vibration sensor produces a vibration output signal upon receiving the known vibration signal, and wherein the known vibration signal and the known sound signal are provided at substantially the same time;
processing the microphone output signal and the vibration output signal produced in response to the respective known sound signal and the known vibration signal to produce a resultant adjusted output signal;
comparing the resultant adjusted output signal to the known sound signal; and
adjusting settings within the processor based on the comparison of the resultant adjusted output signal with the known sound signal to thereby reduce a body vibration signal component in an output signal used for providing auditory stimulation.

34. The method of claim 33, further comprising charging the subcutaneous rechargeable power supply in the implantable auditory prosthesis.

35. The method of claim 34, wherein the implantable auditory prosthesis and the external recharging device comprise coils for inductive charging.

36. The method of claim 35, wherein when the coils are transcutaneously aligned, the speaker and the vibrator are placed in close transcutaneous proximity to the subcutaneous microphone and the subcutaneous vibration sensor, respectively.

37. The method of claim 33, wherein the processor uses an adaptive algorithm for processing, and wherein the settings within the processor are adjusted by adjusting parameters of the adaptive algorithm.

38. The method of claim 33, further comprising transcutaneously aligning the external speaker with the subcutaneous microphone and the vibrator with the subcutaneous vibration sensor.

39. The method of claim 33, wherein the external recharging device is a wearable device for placing the speaker and the vibrator in close transcutaneous proximity to the subcutaneous microphone and the subcutaneous vibration sensor, respectively.

40. The method of claim 39, wherein the wearable device is selected from a behind-the-ear device and a headband.

41. A system, comprising:
an implantable auditory prosthesis having a subcutaneous microphone and a subcutaneous vibration sensor;
an external calibration apparatus having a speaker and a vibrator, wherein said external calibration apparatus is operable to provide calibration signals using said speaker for said subcutaneous microphone and said vibrator for said subcutaneous vibration sensor.

42. The system of claim 41, wherein the speaker and the vibrator are transcutaneously positioned adjacent to the subcutaneous microphone and the subcutaneous vibration sensor, respectively.

43. The system of claim 42, wherein the speaker is located in close proximity with the vibrator, and wherein the subcutaneous microphone is located in close proximity with the subcutaneous vibration sensor.

44. The system of claim 41, wherein the external calibration apparatus is operable to provide calibration signals during a charging time period in which the implantable auditory prosthesis is charged.

45. The system of claim 41, wherein the calibration signals are used to adjust settings associated with the implantable auditory prosthesis to reduce a body vibration signal component in an output signal used for providing auditory stimulation.
